(19) United States
(12) Patent Application Publication
(10) Pub. No.: US 2012/0275172 A1
(43) Pub. Date: Nov. 1, 2012

(54) VEHICULAR HEADLIGHT APPARATUS

(75) Inventor: Ryu Mizuno, Kariya-shi (JP)

(73) Assignee: DENSO CORPORATION, Kariya-city (JP)

(21) Appl. No.: 13/454,589

(22) Filed: Apr. 24, 2012

(30) Foreign Application Priority Data
Apr. 27, 2011 (JP) 2011-099150

(51) Int. Cl. B60Q 1/04

(52) U.S. Cl. 362/464

(57) ABSTRACT

The vehicular headlight apparatus includes a changing means for changing a light illumination area of a headlight, a recognition means for recognizing an object present ahead of the vehicle, an analyzing means for detecting a target object belonging to one of predetermined categories, and calculating positions of a detected target in vertical direction and lateral directions, a control means for controlling the changing means such that, when a target object is detected by the analyzing means, a present light illumination area is changed to a first light illumination area predetermined depending on a category to which the detected target belongs. The control means makes a change from the first light illumination area to a second light illumination area, if the pitch angle of the vehicle is larger than a predetermined value, or a variation amount of the pitch angle per unit time is larger than a predetermined value.

This application claims priority to Japanese Patent Application No. 2011-99150 filed on Apr. 27, 2011, the entire contents of which are hereby incorporated by reference.

### BACKGROUND OF THE INVENTION

1. Field of the Invention

The present disclosure relates to a vehicular headlight apparatus.

2. Description of Related Art

There is known a vehicular headlight apparatus configured to control a light distribution pattern of headlights in order that alight illumination area proper for a target object is illuminated by the light emitted from the headlights. For example, refer to Japanese Patent Application Laid-open No. 2006-21631. In such a vehicular headlight apparatus, a light illumination area is determined uniquely by a light distribution pattern. That is, controlling a light distribution pattern means controlling a light illumination area.

When a target object is detected by an object recognition means such as a camera, the above vehicular headlight apparatus changes the present light distribution pattern so that the light emitted from the headlights covers a light illumination area set for the detected target object. For example, if a preceding vehicle or an oncoming vehicle is detected when the vehicle on which the vehicular headlight apparatus is mounted is in the high beam state or intermediate beam state (the state between the high beam state and the low beam state), the vehicular headlight apparatus changes the present light distribution pattern so that the present light illumination area excluding the detected vehicle is illuminated. This makes it possible to illuminate to a sufficient distance without dazzling the driver of the preceding or oncoming vehicle.

However, since the above vehicular headlight apparatus uses an object recognition means such as a camera or the like, and accordingly it is necessary to perform a process for analyzing the position and so forth of a detected target object based on an image of the target object, it takes a longtime to complete recognition of the target object. Therefore, it may occur that the control of the light illumination area cannot be performed well following actual circumstances during a transient state of the vehicle, for example, when a sharp turn is made, or when quick acceleration or deceleration is made. In such a transient state, it may become difficult to ensure good visibility of a target object due to deviation of the light illumination area from a desired one, or going out of the target object from the light illumination area.

### SUMMARY

An exemplary embodiment provides a vehicular headlight apparatus comprising:

a headlight for illuminating ahead of a vehicle;

a changing means for changing a light illumination area of

the headlight;

a recognition means for recognizing an object present ahead of the vehicle;

an analyzing means for detecting a target object belonging to one of predetermined categories, and calculating positions of a detected target in a vertical direction and in a lateral direction based on result of recognition by the recognition means;

a control means for controlling the changing means such that, when a target object is detected by the analyzing means, a present light illumination area of the headlight is changed to a first light illumination area predetermined depending on a category to which the detected target belongs; and

a pitch angle detecting means for detecting a pitch angle of the vehicle,

wherein

when the present light illumination area has been changed to the first light illumination area, the control means makes a change from the first light illumination area to a second light illumination area different from the first light illumination area, if the pitch angle is larger than a predetermined value, or a variation amount of the pitch angle per unit time is larger than a predetermined value.

Another exemplary embodiment provides a vehicular headlight apparatus comprising:

a headlight for illuminating ahead of a vehicle;

a changing means for changing a light illumination area of the headlight;

a recognition means for recognizing an object present ahead of the vehicle;

an analyzing means for detecting a target object belonging to one of predetermined categories, and calculating positions of a detected target in a vertical direction and in a lateral direction based on result of recognition by the recognition means;

a control means for controlling the changing means such that, when a target object is detected by the analyzing means, a present light illumination area of the headlight is changed to a first light illumination area predetermined depending on a category to which the detected target belongs; and

a yaw angle detecting means for detecting a yaw angle of the vehicle,

wherein

when the present light illumination area has been changed to the first light illumination area, the control means makes a change from the first light illumination area to a second light illumination area different from the first light illumination area, if the yaw angle is larger than a predetermined value, or a variation amount of the yaw angle per unit time is larger than a predetermined value.

Another exemplary embodiment provides a vehicular headlight apparatus comprising:

a headlight for illuminating ahead of a vehicle;

a changing means for changing a light illumination area of the headlight;

a recognition means for recognizing an object present ahead of the vehicle;

an analyzing means for detecting a target object belonging to one of predetermined categories, and calculating positions of a detected target in a vertical direction and in a lateral direction based on result of recognition by the recognition means;

a control means for controlling the changing means such that, when a target object is detected by the analyzing means, a present light illumination area of the headlight is changed to a first light illumination area predetermined depending on a category to which the detected target belongs;

a pitch angle detecting means for detecting a pitch angle of the vehicle; and

a yaw angle detecting means for detecting a yaw angle of the vehicle;

wherein

when the present light illumination area has been changed to the first light illumination area, the control means makes a change from the first light illumination area to a second light illumination area different from the first light illumination area, if the pitch angle is larger than a predetermined value, if a variation amount of the pitch angle per unit time is larger than a predetermined value, if the yaw angle is larger than a predetermined value, or if a variation amount of the yaw angle per unit time is larger than a predetermined value.

According to the exemplary embodiments, there are provided vehicular headlight apparatuses which provide a vehicle driver with good visibility of an object present ahead of a vehicle even when the vehicle is in a transient state.

Other advantages and features of the invention will become apparent from the following description including the drawings and claims.

### BRIEF DESCRIPTION OF THE DRAWINGS

In the accompanying drawings:

FIG. 1 is a block diagram showing the structure of a vehicular headlight apparatus according to an embodiment of the invention;

FIG. 2 is a diagram schematically explaining a light illumination area set by the vehicular headlight apparatus; and

FIG. 3 is a flowchart showing an operation of the vehicular headlight apparatus.

### PREFERRED EMBODIMENTS OF THE INVENTION

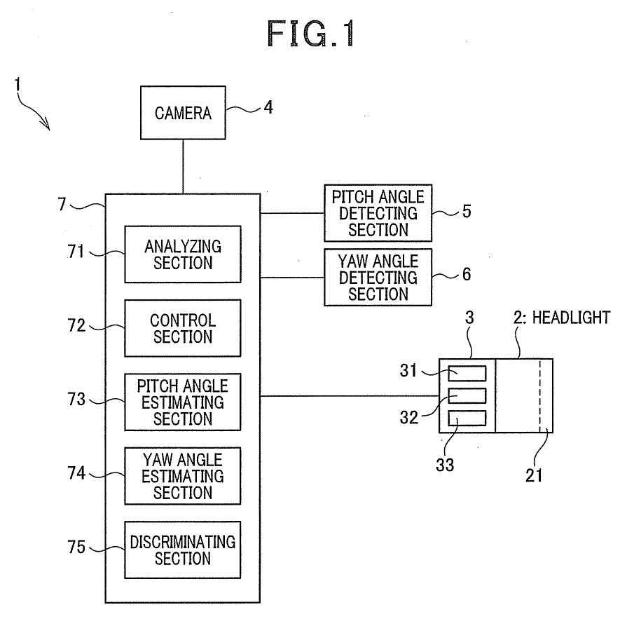

As shown in FIG. 1, the vehicular headlight apparatus 1 according to an embodiment of the invention includes headlights 2, light distribution changing sections 3, a camera 4, a pitch angle detecting section 5, a yaw angle detecting section 6 and an ECU (Electronic Control Unit) 7.

Each headlight 2 includes a light source (not shown), a reflector (not shown) and a slit-plate 21. The headlights 2 are mounted on the front left portion and the front right portion of a vehicle, respectively. The slit-plate 21 is disposed in the front of each headlight 2.

The light distribution changing section 3 provided in each headlight 2 includes a driver motor 31, a leveling motor 32 and a swivel motor 33. The drive motor drives the slit-plate 21 in accordance with a command received from the ECU 7. The leveling motor 32 changes the light axis of the headlight 2 in the up-down direction in accordance with a command received from the ECU 7. The swivel motor 33 changes the optical axis of the headlight 2 in the left-right direction in accordance with a command received from the ECU 7.

A part of the light source of the headlight 2 at which it is covered by the slit-plate 21 is determined depending on the position of the slit-plate 21. By partially covering the light source, it is possible to form a dark part (shadow) in a light illumination area. A light distribution pattern is determined in accordance with the angles of the light axis in the up-down and left-right directions, and the position of the slit-plate 21 of each of the headlights 2. A light illumination area is determined in accordance with a light distribution pattern. In this embodiment, to change the present light illumination area, the light distribution changing section 3 drives the light axis of the light source and the slit-plate 21 for each of the headlights 2 to change the light distribution pattern.

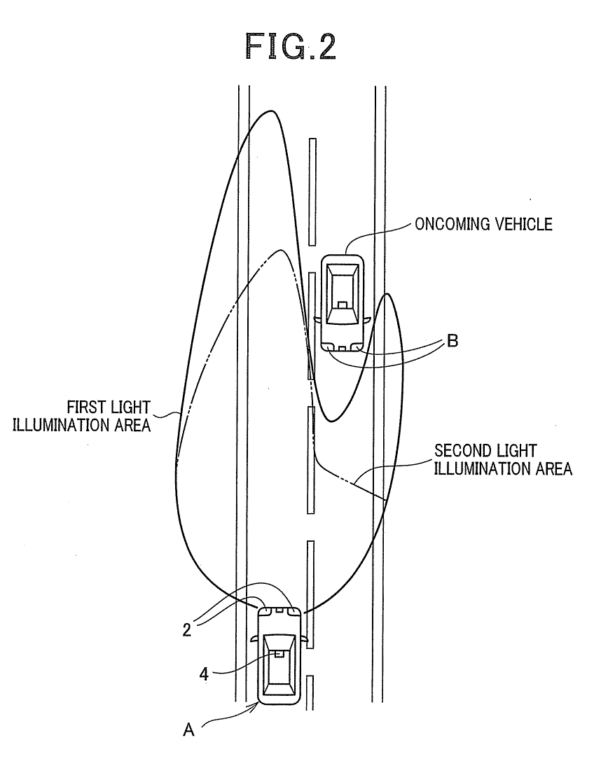

The cameral 4 as an image sensor takes an image ahead of the vehicle. An infrared ray is used for taking an image of a pedestrian or the like. As shown in FIG. 2, the camera 4 is mounted on a top portion of the vehicle. The camera 4 transmits image data of a taken image to the ECU 7.

The pitch angle detecting section 5, which is a vehicle speed sensor, detects the vehicle speed. The pitch angle detecting section 5 transmits vehicle speed data as pitch angle data to the ECU 7. This is possible because the pitch angle or a variation amount of the pitch angle can be estimated based on a variation amount of the vehicle speed.

The yaw angle detecting section 6, which is a steering angle sensor, detects the yaw angle of the vehicle, and transmits yaw angle data indicative of the detected yaw angle to the ECU 7.

The ECU 7 is a microcomputer-based electronic control unit for controlling the light distributing changing section 3. Functionally, the ECU 7 includes an analyzing section 71, a control section 72, a pitch angle estimating section 73, a yaw angle estimating section and a discriminating section 75.

The analyzing section 71 is for analyzing the image data transmitted from the camera 4. More specifically, the analyzing section 71 detects a target object B, and calculates the positions of the target object B in each of the vertical direction (up-down direction) and the lateral direction (left-right direction) based on the image data transmitted from the camera 4. The target object B may be headlights of an oncoming vehicle, taillights of a preceding vehicle, or a pedestrian. The analyzing section 71 may be incorporated in the camera 4.

The control section 72 has a function of controlling the light distribution changing section 3. The control section 72 stores a first light illumination area corresponding to a first light distribution pattern. When the target object B is detected by the analyzing section 71, the control section 72 makes a change to the first light illumination area based on the results of the analysis by the analyzing section 71. The first light illumination area is a light illumination area (light distribution pattern) set in advance for each of categories of target objects. In other words, the first light illumination area is a light illumination area set in advance depending on a distance to a target object. Changing to the first light illumination is made when the vehicle is in the high-beam state or intermediate-beam state.

For example, when the target object B is headlights of an oncoming vehicle, the first light illumination area is the present light illumination area excluding an area near the oncoming vehicle. The position of the area to be excluded changes in accordance with movement of the target object. Accordingly, the first light illumination area is an area to be tracked in accordance with the position of the target object.

The above is the same when the target object B is taillights of a preceding vehicle. When the target object B is a pedestrian, an area near the feet of the pedestrian is positively included to the present light illumination area so that the driver can easily recognize the pedestrian. Each of a target object and the first light illumination area may be set plurally. A second light illumination area will be explained later.

The pitch angle estimating section 73 calculates the present pitch angle or a change rate (a change amount per unit time) of the pitch angle based on the pitch angle data transmitted from the pitch angle detecting section 5. Incidentally, it is possible to estimate a change amount of the pitch angle due to rapid increase or decrease of the vehicle speed also by referring to a database prepared in advance.

The yaw angle estimating section 7 calculates the present yaw angle or yaw rate (a variation amount of the yaw angle per unit time) based on the yaw angle data transmitted from the yaw angle detecting section 6. The yaw rate is a rotational angular speed in the yawing direction. When the yaw angle detecting section 6 is constituted of a steering angle sensor, a detected yaw angle can be used as the present yaw angle. When the yaw angle detecting section 6 is constituted of a yaw rate sensor, a detected yaw rate can be used as the present yaw rate.

The discriminating section 75 stores a threshold value regarding the pitch angle, a threshold value regarding a change amount of the pitch angle, a threshold value regarding the yaw angle, and a threshold value regarding a change amount of the yaw angle. The discriminating section 75 compares an estimation result received from the pitch angle estimating section 73 with the threshold value during a period while the control section 72 controls the present light illumination area to the first light illumination area, and commands the control section 72 to change the present light illumination area to the second light illumination area if the estimation result exceeds the threshold value. Also, the discriminating section 75 compares an estimation result received from the yaw angle estimating section 74 with the threshold value during a period while the control section 72 controls the present light illumination area to the first light illumination area, and commands the control section 72 to change the present light illumination area to the second predetermined light illumination area if the estimation result exceeds the threshold value. The control section 72 controls the light distribution changing sections 3 in accordance with the commands received from the discriminating section 75.

That is, the discriminating section 75 changes the present light illumination area from the first light illumination area to the second light illumination area upon detecting fulfillment of at least one of conditions (1) an estimated pitch angle exceeds the threshold, (2) an estimated variation amount of the pitch angle exceeds the threshold, (3) an estimated yaw angle exceeds the threshold, and (4) an estimated yaw rate exceeds the threshold.

The second light illumination area is an area set depending on a kind of a detected target object while the vehicle is in a transient state. In this embodiment, the second light illumination area is set wider than the first light illumination area when a detected target object is a pedestrian, and set to an area covered by the headlights in the low-beam state when a detected target object is headlights or taillights of an oncoming vehicle or preceding vehicle (See the chain double-dashed line in FIG. 2). However, the second light illumination area may be set narrower than the first illumination area and wider than the area covered by the headlights in the low-beam state when a detected target object is headlights or taillights of an oncoming vehicle or preceding vehicle.

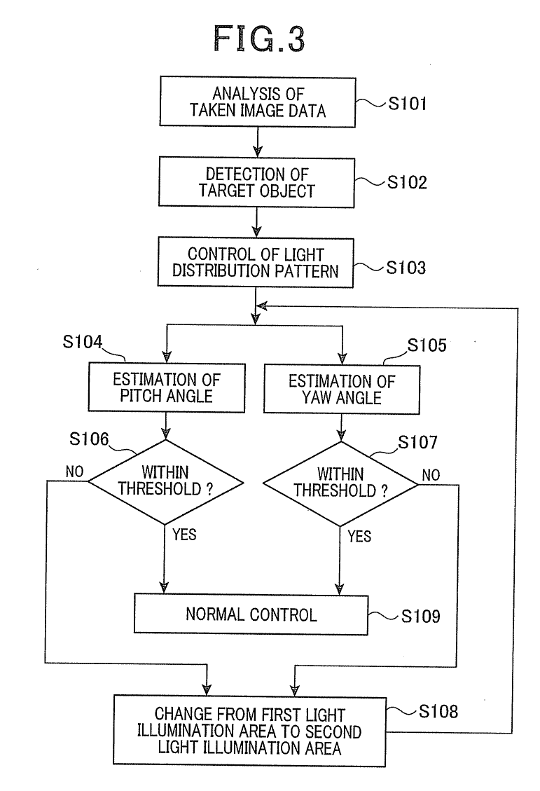

Next, an operation of the vehicular headlight apparatus is explained with reference to the flowchart of FIG. 3. At the beginning, the camera 4 transmits image data of a taken image to the ECU 7, and the analyzing section 71 analyzes the image data in step S101. The analyzing section 71 detects a target object B, and calculates a position of the detected target object B in step S102. The control section 72 controls the light distribution changing section 3 so that the first light illumination area is set for the target object B in step S103. At this time, the pitch angle detecting section 5 and the yaw angle detecting section 6 are transmitting data indicative of detection results to the ECU 7.

The pitch angle estimating section 73 estimates the present pitch angle a variation amount of the pitch angle based on the data received from the pitch angle detecting section 5 in step S104. The yaw angle estimating section 74 estimates the present yaw angle and the yaw rate based on the data received from the yaw angle detecting section 6 in step S105.

In step S106, it is determined whether or not both the estimated present pitch angle and the estimated variation amount of the pitch angle are within the corresponding thresholds. If the determination result in step S106 is negative, that is, if at least one of the estimated present pitch angle and the estimated variation amount of the pitch angle exceeds the corresponding threshold, the operation proceeds to step S108 where the ECU 7 makes a change from the first light illumination area to the second light illumination area. If the determination result in step S106 is positive, the operation proceeds to step S109 where the ECU 7 maintains the first light illumination area.

Subsequently, in step S107, it is determined whether or not both the estimated present yaw angle and the estimated yaw rate are within the corresponding thresholds. If the determination result in step S107 is negative, that is, if at least one of the estimated present yaw angle and the estimated yaw rate exceeds the corresponding threshold, the operation proceeds to step S108 where the ECU 7 makes a change from the first light illumination area to the second light illumination area. If the determination result in step S107 is positive, the operation proceeds to step S109 where the ECU 7 maintains the first light illumination area. In step S109, if the transient state ends and the above estimated values becomes smaller than the thresholds, return to the normal control is made.

According to the above described embodiment, the light illumination area is set wider when a pedestrian is detected so that the pedestrian can be recognized easily, and set narrower when an oncoming vehicle or a preceding vehicle is detected so that the headlights illuminate to a sufficient distance without dazzling the driver of the oncoming or preceding vehicle.

### Modifications

It is a matter of course that various modifications can be made to the above described embodiment as described below.

The pitch angle detecting section 5 may be a car navigation device that provides road unevenness information, an accelerator opening degree sensor, brake pressure sensor, an accelerator sensor, or a vehicle height sensor. It is possible to estimate the present pitch angle and a variation amount of the pitch angle based on data received from such a device or sensors. By using a vehicle height sensor as the pitch angle detecting section 5, it is possible to directly detect the pitch angle. Particularly, in a case where a vehicle height sensor is used to detect the pitch angle when a vehicle is in the low beam state, this vehicle height sensor can be used also as the pitch angle detecting section 5 directly as it is.

The yaw angle detecting section 6 may be a car navigation device that provides road curve information, a yaw rate sensor, or an acceleration sensor that provides data indicative of leftward or rightward acceleration. That is, the pitch angle detecting section 5 may be the one that directly detects the pitch angle, or the one that indirectly detects the pitch angle. Instead of the camera 4, a laser radar may be used as an object recognition means.

The vehicular headlight apparatus 1 may be configured such that the discriminating section 75 detects or estimates only one of a group of the pitch angle and a variation amount of pitch angle, and a group of the yaw angle and the yaw rate. Further, the vehicular headlight apparatus 1 may be configured such that the discriminating section 75 detects or estimates only one of the pitch angle, a variation amount of the pitch angle, the yaw angle, and the yaw rate.

The second light illumination area may be set differently depending on a case. For example, the second light illumination area may be set differently between a case where the pitch angle (or variation amount of the pitch angle) exceeds the threshold and the yaw angle (or yaw rate) is within a threshold, and a case where the pitch angle (or variation amount of the pitch angle) exceeds the threshold and also the yaw angle (or yaw rate) exceeds the threshold.

The second light illumination area may be set to the low-beam light illumination area for all kinds of target objects. The control section 72 may be configured to stop operation (or partially operate) when the discriminating section 75 determines that the vehicle is in a transient state. In other words, the control section 72 may be configured to stop tracking a target object (or partially track a target object) when the discriminating section 75 determined that the vehicle is in a transient state. Also in this case, the second light illumination area is set differently from the first light illumination area which is set for a relatively moving target object. Also by the above simple configuration, it is possible to illuminate to a sufficient distance without dazzling the driver of an oncoming vehicle or a preceding vehicle.

The headlight 2 may not be provided with the slit-plate 21. For example, the headlight 2 may have a plurality of light sources, and the light distribution pattern changing section 3 may be configured to determine a light illumination area based on a principle of a projector.

The above explained preferred embodiments are exemplary of the invention of the present application which is described solely by the claims appended below. It should be understood that modifications of the preferred embodiments may be made as would occur to one of skill in the art.

What is claimed is:

1. A vehicular headlight apparatus comprising:
a headlight for illuminating ahead of a vehicle;
a changing means for changing a light illumination area of the headlight;
a recognition means for recognizing an object present ahead of the vehicle;
an analyzing means for detecting a target object belonging to one of predetermined categories, and calculating positions of a detected target in a vertical direction and in a lateral direction based on result of recognition by the recognition means;
a control means for controlling the changing means such that, when a target object is detected by the analyzing means, a present light illumination area of the headlight is changed to a first light illumination area predetermined depending on a category to which the detected target belongs; and
a pitch angle detecting means for detecting a pitch angle of the vehicle,
wherein
when the present light illumination area has been changed to the first light illumination area, the control means makes a change from the first light illumination area to a second light illumination area different from the first light illumination area, if the pitch angle is larger than a predetermined value, or a variation amount of the pitch angle per unit time is larger than a predetermined value.

2. The vehicular headlight apparatus according to claim 1, wherein the second light illumination area is set wider than the first light illumination area when the detected target object is a pedestrian.

3. The vehicular headlight apparatus according to claim 1, wherein the second light illumination area is set narrower than the first light illumination area and wider than a light illumination area covered by the headlights in a low-beam state when the detected target object is headlights of an oncoming vehicle or taillights of a preceding vehicle.

4. A vehicular headlight apparatus comprising:
a headlight for illuminating ahead of a vehicle;
a changing means for changing a light illumination area of the headlight;
a recognition means for recognizing an object present ahead of the vehicle;
an analyzing means for detecting a target object belonging to one of predetermined categories, and calculating positions of a detected target in a vertical direction and in a lateral direction based on result of recognition by the recognition means;
a control means for controlling the changing means such that, when a target object is detected by the analyzing means, a present light illumination area of the headlight is changed to a first light illumination area predetermined depending on a category to which the detected target belongs; and
a yaw angle detecting means for detecting a yaw angle of the vehicle,
wherein
when the present light illumination area has been changed to the first light illumination area, the control means makes a change from the first light illumination area to a second light illumination area different from the first light illumination area, if the yaw angle is larger than a predetermined value, or a variation amount of the yaw angle per unit time is larger than a predetermined value.

5. The vehicular headlight apparatus according to claim 4, wherein the second light illumination area is set wider than the first light illumination area when the detected target object is a pedestrian.

6. The vehicular headlight apparatus according to claim 4, wherein the second light illumination area is set narrow than the first light illumination area and wider than a light illumination area covered by the headlights in a low-beam state when the detected target object is headlights of an oncoming vehicle or taillights of a preceding vehicle.

7. A vehicular headlight apparatus comprising:
a headlight for illuminating ahead of a vehicle;
a changing means for changing a light illumination area of the headlight;
a recognition means for recognizing an object present ahead of the vehicle;
an analyzing means for detecting a target object belonging to one of predetermined categories, and calculating positions of a detected target in a vertical direction and in a lateral direction based on result of recognition by the recognition means;
a control means for controlling the changing means such that, when a target object is detected by the analyzing means, a present light illumination area of the headlight is changed to a first light illumination area predetermined depending on a category to which the detected target belongs;
a pitch angle detecting means for detecting a pitch angle of the vehicle; and
a yaw angle detecting means for detecting a yaw angle of the vehicle;
wherein
when the present light illumination area has been changed to the first light illumination area, the control means makes a change from the first light illumination area to a second light illumination area different from the first light illumination area, if the pitch angle is larger than a predetermined value, if a variation amount of the pitch angle per unit time is larger than a predetermined value, if the yaw angle is larger than a predetermined value, or if a variation amount of the yaw angle per unit time is larger than a predetermined value.

8. The vehicular headlight apparatus according to claim 7, wherein the second light illumination area is set wider than the first light illumination area when the detected target object is a pedestrian.

9. The vehicular headlight apparatus according to claim 7, wherein the second light illumination area is set narrow than the first light illumination area and wider than a light illumination area covered by the headlights in a low-beam state when the detected target object is headlights of an oncoming vehicle or taillights of a preceding vehicle.
